(19) United States
(12) Patent Application Publication
(10) Pub. No.: US 2019/0220502 A1
(43) Pub. Date: Jul. 18, 2019

(54) VALIDATION DEVICE, VALIDATION METHOD, AND COMPUTER-READABLE RECORDING MEDIUM

(71) Applicant: Fujitsu Limited, Kawasaki-shi (JP)

(72) Inventors: Naoto Ohkuni, Kunitachi (JP); Masahiro Kataoka, Kamakura (JP)

(73) Assignee: Fujitsu Limited, Kawasaki-shi (JP)

(21) Appl. No.: 16/216,153

(22) Filed: Dec. 11, 2018

(30) Foreign Application Priority Data
Jan. 12, 2018 (JP) 2018-003561

(51) Int. Cl. G06F 17/22

(52) U.S. Cl. CPC G06F 17/2276; G06F 17/2217; G06F 17/2247

(57) ABSTRACT

A non-transitory computer-readable recording medium stores therein a validation program that causes a computer to execute a process including: creating, by using an encoding dictionary in which a tag name or a definition value of each of a plurality of tags is associated with a code, an encoding XML definition file by encoding each of a plurality of XML definition files that are a validation target; creating a schema association index by using the encoding dictionary from schemas associated with the plurality of XML definition files; and validating the encoding XML definition file by using the schema association index.

### CROSS-REFERENCE TO RELATED APPLICATION

This application is based upon and claims the benefit of priority of the prior Japanese Patent Application No. 2018-003561, filed on Jan. 12, 2018, the entire contents of which are incorporated herein by reference.

### FIELD

The embodiment discussed herein is related to a computer-readable recording medium and the like.

### BACKGROUND

There are XML definition files as data in an extensible markup language (XML) format. The XML definition files are files of data registered as users' assets. Such XML definition files are validated by using XML schemas in which definitions that constrain the logical structure of the XML definition files are described.

Conventionally, validation of a plurality of XML definition files that are the validation target is performed as follows. For example, the validation process reads an XML schema for each validation of a XML definition file that is the validation target and performs a validation work of the XML definition files.

Patent Document 1: Japanese Laid-open Patent Publication No. 2007-34827

Patent Document 2: Japanese Laid-open Patent Publication No. 2013-246522

### SUMMARY

According to an aspect of the embodiment, a non-transitory computer-readable recording medium stores therein a validation program that causes a computer to execute a process including: creating, by using an encoding dictionary in which a tag name or a definition value of each of a plurality of tags is associated with a code, an encoding XML definition file by encoding each of a plurality of XML definition files that are a validation target; creating a schema association index by using the encoding dictionary from schemas associated with the plurality of XML definition files; and validating the encoding XML definition file by using the schema association index.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a reference example of XML schema validation of XML definition files;

FIG. 2 is a diagram illustrating an example of the XML schema validation of XML definition files according to an embodiment;

FIG. 3 is a functional block diagram illustrating a configuration of an information processing apparatus according to the embodiment;

FIG. 4 is a diagram illustrating an encoding dictionary according to the embodiment;

FIG. 5 is a diagram illustrating an example of an XML schema;

FIG. 6 is a diagram illustrating an example of the data structure of an inverted index according to the embodiment;

FIG. 7 is a diagram illustrating the flow of an index creating process according to the embodiment;

FIG. 8A is a diagram (1) illustrating the flow of a schema validation process according to the embodiment;

FIG. 8B is a diagram (2) illustrating the flow of a schema validation process according to the embodiment;

FIG. 8C is a diagram (3) illustrating the flow of a schema validation process according to the embodiment;

FIG. 8D is a diagram (4) illustrating the flow of a schema validation process according to the embodiment;

FIG. 8E is a diagram (5) illustrating the flow of a schema validation process according to the embodiment;

FIG. 8F is a diagram (6) illustrating the flow of a schema validation process according to the embodiment;

FIG. 9 is a diagram illustrating an example of the flowchart of the index creating process according to the embodiment;

FIG. 10 is a diagram illustrating a specific example of the index creating process according to the embodiment;

FIG. 11 is a diagram illustrating an example of the flowchart of the schema validation process according to the embodiment;

FIG. 12 is a diagram illustrating an example of the flowchart of a start tag process according to the embodiment;

FIG. 13 is a diagram illustrating an example of the effect of the XML schema validation according to the embodiment;

FIG. 14 is a diagram illustrating a hardware configuration example of a computer;

FIG. 15 is a diagram illustrating a configuration example of a program operated by the computer; and

FIG. 16 is a diagram illustrating a configuration example of a system according to the embodiment.

### DESCRIPTION OF EMBODIMENT(S)

However, there is a problem in that, in the XML schema validation of a plurality of XML definition files, it is not able to perform the validation work at high speed.

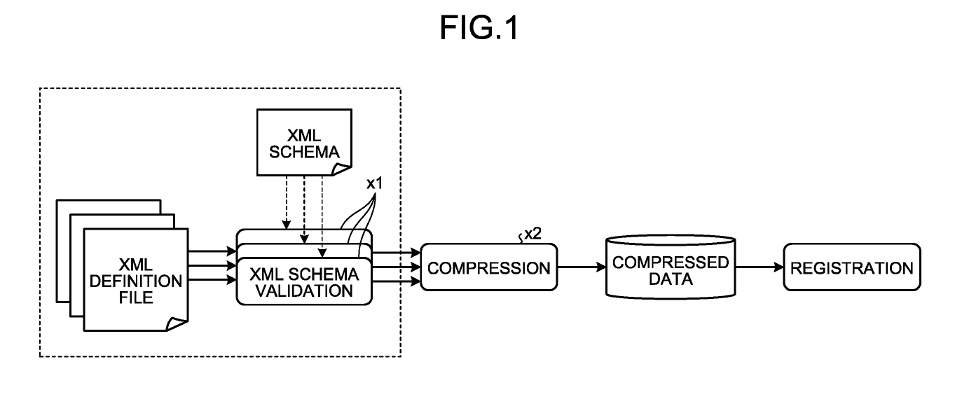

Here, a problem in that, in the XML schema validation of a plurality of XML definition files, it is not able to perform the validation work at high speed will be described with reference to FIG. 1. FIG. 1 is a diagram illustrating a reference example of XML schema validation of XML definition files. As illustrated in FIG. 1, when XML schema validation is performed on a plurality of XML definition files, the validation process reads an XML schema for each XML definition file and performs, by using the read XML schema, a validation work on the XML definition files (x1). Thus, because the validation process needs to read the XML schemas by the number of times corresponding to the number of XML definition files to be validated and repeat the validation work of the XML definition files, the IO load and the CPU load become high. Consequently, in XML schema validation of the plurality of XML definition files, it is not able to perform the validation work at high speed. Furthermore, thereafter, the XML definition files that have been successfully validated are compressed (x2) and registered in compressed data.

Preferred embodiments will be explained with reference to accompanying drawings. Furthermore, the present invention is not limited to the embodiments.

Example of XML schema validation of an XML definition file according to the embodiment

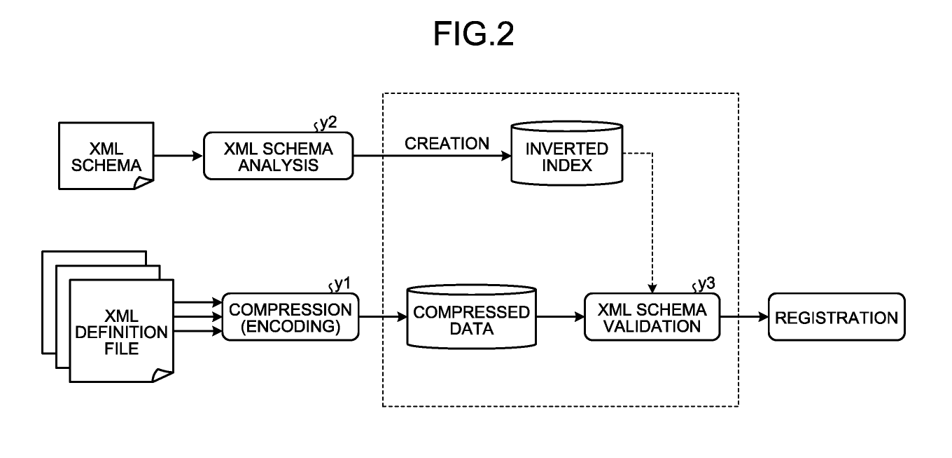

FIG. 2 is a diagram illustrating an example of the XML schema validation of XML definition files according to an embodiment.

As illustrated in FIG. 2, the XML schema validation process uses an encoding dictionary in which a tag name or a definition value of each of a plurality of tags is associated with a code, encodes each of the plurality of XML definition files that are the validation target, and then creates an integrated encoding XML definition file (y1). The XML schema analysis process uses the encoding dictionary obtained from the XML schemas associated with the plurality of XML definition files and creates an inverted index related to the XML schemas (y2).

Then, the XML schema validation process validates the encoding XML definition file by using the inverted index (y3). Consequently, the XML schema validation process reads the inverted index related to the XML schema only once that corresponds to the number of encoding XML definition files to be validated and performs a validation work of the encoding XML definition file, whereby XML schema validation process can perform the validation work at high speed. Namely, when compared with a case in which validation is performed by reading an XML schema for each of the plurality of XML definition files, the IC load and the CPU load are decreased and the XML schema validation process can thus perform the validation work at high speed.

The XML definition file mentioned here is a file in which both tags and definition values are present in a mixed manner. A tag indicates a character string starting from a start symbol “<” and ending at an end symbol “>” and includes a start tag and an end tag. For example, data in an XML definition file is “<Endpoint><ServiceName>ser01</ServiceName></Endpoint>”. In this data, <Endpoint>is the start tag and </Endpoint>is the end tag. In this data, <ServiceName>is the start tag and </ServiceName>is the end tag. In this data, “serol” is the content of an element from the start tag to the end tag and is referred to as, in the embodiment, content.

Configuration of an information processing apparatus according to the embodiment.

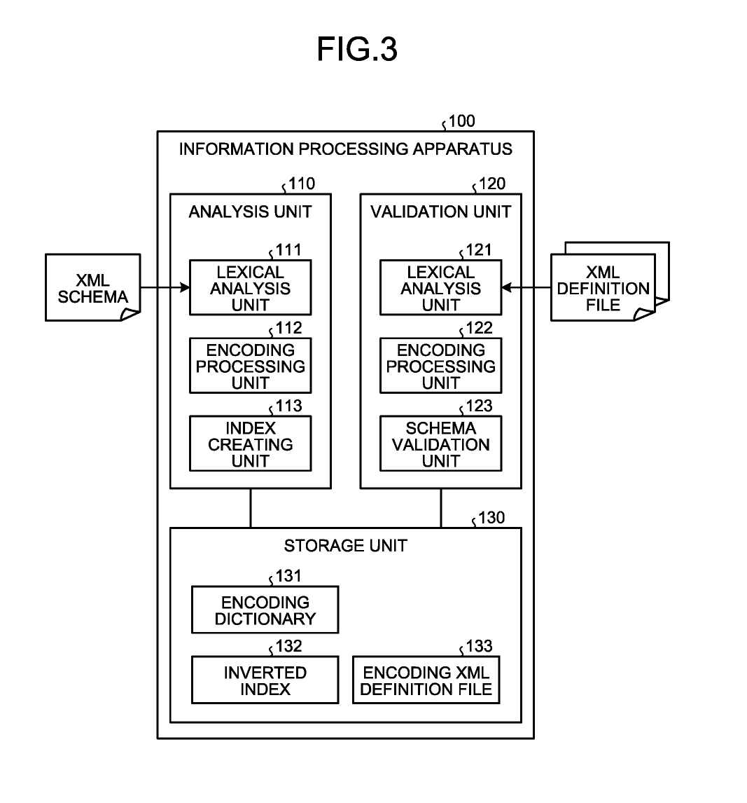

FIG. 3 is a functional block diagram illustrating a configuration of an information processing apparatus according to the embodiment. As illustrated in FIG. 3, an information processing apparatus 100 includes an analysis unit 110, a validation unit 120, and a storage unit 130.

The storage unit 130 corresponds to a storage device of, for example, a nonvolatile semiconductor memory device, such as a flash memory or a ferroelectric random access memory (FRAM) (registered trademark). The storage unit 130 includes an encoding dictionary 131, an inverted index 132, and an encoding XML definition file 133. Furthermore, the inverted index 132 is an example of a schema association index.

The encoding dictionary 131 is a dictionary that is used when XML schemas and XML definition files are encoded. The encoding dictionary 131 is a dictionary in which, based on general XML definition files, XML schemas, and the like, a frequency of appearance of keywords and the definition value appearing in the XML definition files are specified and a code having a smaller length is assigned to keywords or definition values that appear more frequently. The keyword mentioned here is, for example, a tag name of a tag. In the definition value, for example, content, the type of a tag, data type, the number of appearances, and the like are included.

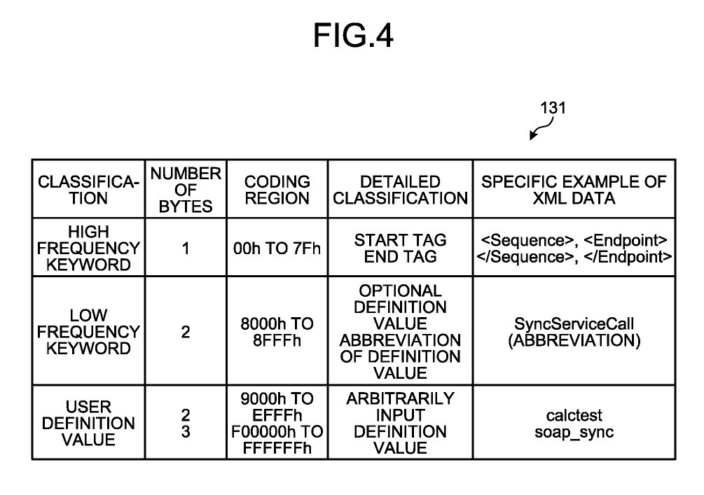

In the following, the encoding dictionary 131 will be described with reference to FIG. 4. FIG. 4 is a diagram illustrating an encoding dictionary according to the embodiment. In FIG. 4, as an example of the encoding dictionary 131, the number of bytes, a coding region, detailed classification, and a specific example of XML data are illustrated for each classification.

In the classification, a high frequency keyword, a low frequency keyword, and a user definition value are illustrated. The high frequency keyword that is used as one of the classifications indicates a keyword with a high frequency of appearance and an example thereof includes a start tag or an end tag indicated by the detailed classification. The low frequency keyword that is used as one of the classifications indicates a keyword with a low frequency of appearance and an example thereof includes an optional definition value or an abbreviation of definition value indicated in the detailed classification. The user definition value used as one of the classifications indicates a keyword with a low frequency of appearance and an example thereof includes a definition value that is arbitrarily input and that is indicated in the detailed classification.

The number of bytes is the number of bytes of a sign code that is a compression code. The number of bytes associated with the high frequency keyword is “1”. The number of bytes associated with the low frequency keyword is “2”. The number of bytes associated with the user definition value is “2” or “3”.

The coding region is the region in which encoding is available. The coding region associated with the high frequency keyword is “00h to 7Fh”. The coding region associated with the low frequency keyword is “8000h to 8FFFh”. The coding region associated with the user definition value is, when the number of bytes is “2”, “9000h to EFFFh”, and is, when the number of bytes is “3”, “F00000h to FFFFFFh”.

Furthermore, the coding region may also previously be associated with the data type. For example, from among “9000h to EFFFh”, “9000h to AFFFh” may also be associated with a character string type. From among “9000h-EFFFh”, “B000h to CFFFh” may also be associated with a value type and, from among “9000h to EFFFh”, “D000h to EFFFh” may also be associated with a data type.

A specific example of the XML data is indicated by a specific example of a keyword or a definition value for each classification. A specific example of the XML data associated with a high frequency keyword includes <Sequence>, </Sequence>, <Endpoint>, and </Endpoint>. A specific example of the XML data associated with a low frequency keyword includes “SyncServiceCall” or an abbreviation. A specific example of the XML data associated with a user definition value includes “calctest” and “soap sync”. Furthermore, in the high frequency keyword and the low frequency keyword, each of the sign codes of the coding regions and each of the keywords are previously allocated and registered. In the user definition value, each of the sign code of the coding regions and each of the definition values are not previously allocated. At the time of encoding, when a definition value appears, a sign code is allocated and registered.

As an example, “<Sequence>” that is an example of the start tag is allocated to “00h” and “</Sequence>” that is the end tag associated with the start tag is allocated to “40h”. Furthermore, “<Endpoint>” that is an example of the start tag is allocated to “05h” and “</Endpoint>” that is the end tag associated with the start tag is allocated to “45h”. Furthermore, in the embodiment, it is assumed that the codes of the start tag are “00h” to “3Fh” and the end tag associated with the start tag is the value obtained by adding “40h” to the code of the start tag.

A description will be given here by referring back to FIG. 3. The inverted index 132 is an index for storing the appearance positions of the tags and the definition values included in the XML schema. Namely, the inverted index 132 mentioned here indicates a bit map of the presence or absence of the tags and the definition values included in the XML schema indexed for each offset (appearance position).

The “XML schema” that is the data source of the inverted index 132 indicates the file in which the definition that constraints the logical structure of the XML definition file is described and is the file that is used to validate the validity of the logical structure of the XML definition file. In other words, in the XML schema, the rule for each tag is described.

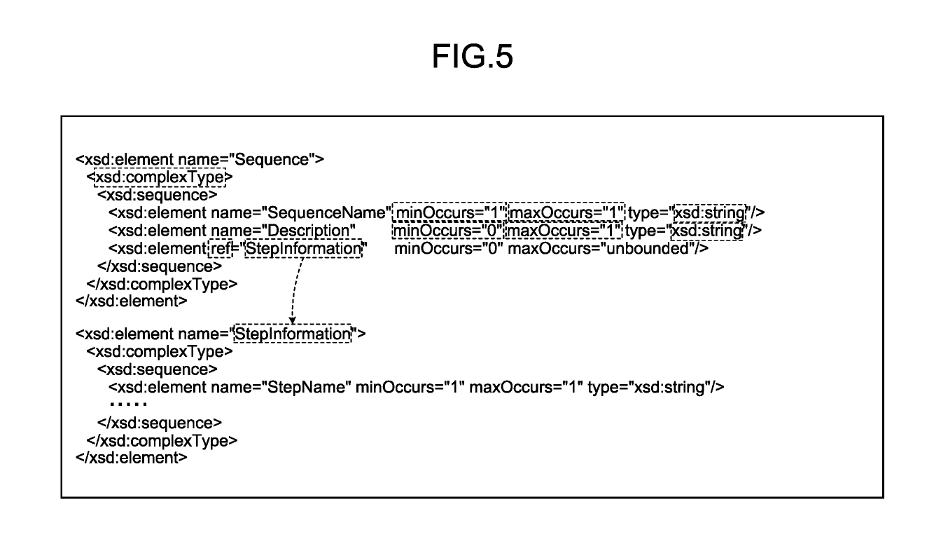

In the following, an example of the XML schema will be described with reference to FIG. 5. FIG. 5 is a diagram illustrating an example of an XML schema. As illustrated in FIG. 5, in the XML schema, the rule for the tags is described.

For example, if “element name” (a tag name of the start tag) is “Sequence”, the tag of “xsd:complexType” is further described. “xsd:complexType” mentioned here indicates an element (complex type) having a child element. Furthermore, “xsd:complexType” indicates the property related to “Sequence”. Thus, “Sequence” and “complexType” are represented by different tags; however, both can be the units of the same meanings in XML.

Furthermore, if “element name” (a tag name of the start tag) is “SequenceName”, information on the number of appearances and the data type is described. As the information on the number of appearances, the minimum number of appearances and the maximum number of appearances are described. “minOccurs=“1”” indicating that the number of appearances is one time as the minimum number of appearances and “maxOccurs=“1”” indicating that the number of appearances is one time as the maximum number of appearances are described. Namely, this indicates that the number of appearances is one time. “xsd:string” indicates a character string type.

Furthermore, if another “element name” (a tag name of the start tag) is “Description”, “minOccurs=“0”” indicating zero times is described as the minimum number of appearances and “maxOccurs=“1”” indicating one time is described as the maximum number of appearances. Namely, the number of appearances is zero to one times. As the information on the data type, “xsd:string” is described.

Furthermore, if “element ref” (a tag name of the start tag) is “StepInformation”, this indicates that the rule is further described at the position in which “StepInformation” that is the same value as that of the tag name is defined. Here, the information described at the latter part “element name=”StepInformation” (a tag name of the start tag) to the tail end of “/xsd:element” (a tag name of the end tag) is further described as the rule of “StepInformation”.

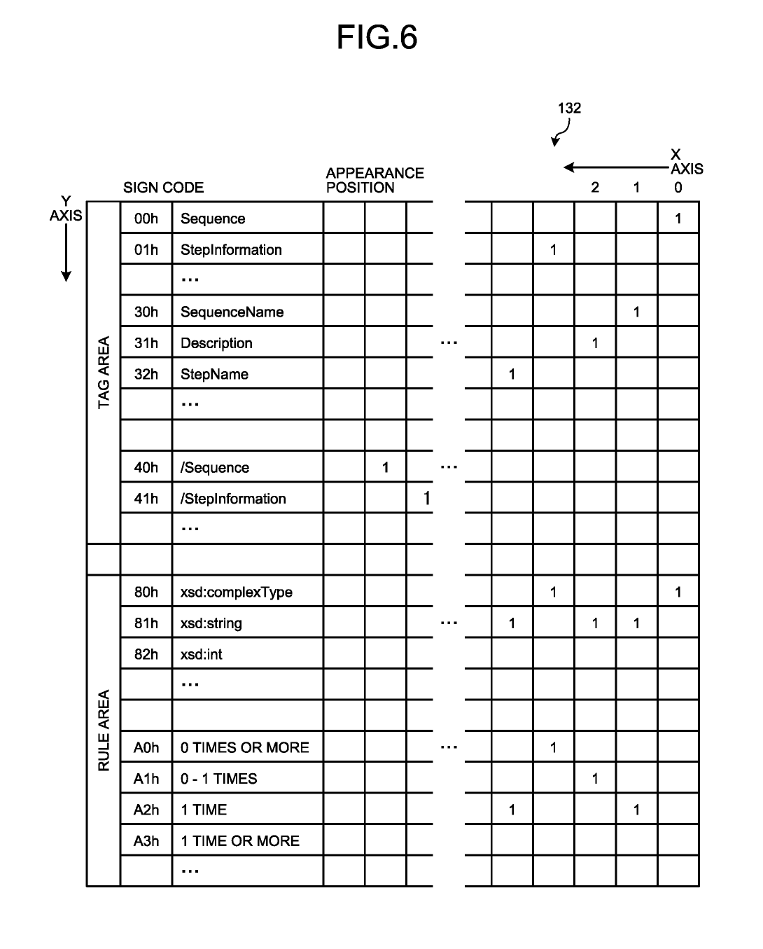

In the following, an example of the data structure of the inverted index 132 of the XML schema will be described with reference to FIG. 6. FIG. 6 is a diagram illustrating an example of the data structure of an inverted index according to the embodiment. As illustrated in FIG. 6, the X-axis of the inverted index 132 indicates offset (appearance position) of the XML schema and the Y-axis includes a tag area and a rule area. In the tag area, a sign code is set together with the tag name of the start tag and the end tag. The tag area is information on, for each tag name, a bundle of the index related to the appearance position in the XML schema. In the rule area, a sign code is set together with the definition value. The rule area is information, for each definition value, a bundle of the index related to the appearance positions in the XML schema. At the appearance position in which each of the tag names and the definition values appear in the XML schema, ON, i.e., “1”, that is a binary number is set as an appearance bit. At the position in which each of the tag names and the definition values do not appear in the XML schema, OFF, i.e., “0”, that is a binary number is set as an appearance bit. Furthermore, in the embodiment, if an appearance bit is “0”, a description of “0” will be omitted.

As an example, at the 0^{th} appearance position, as the tag name, the bit associated with “Sequence” is set to ON, i.e., an appearance bit indicating a binary number of “1” is set. Furthermore, as the definition value, the bit associated with “xsd:complexType” is set to ON, i.e., an appearance bit indicating a binary number of “1” is set.

A description will be given here by referring back to FIG. 3. The encoding XML definition file 133 is a file obtained by encoding and integrating each of a plurality of XML definition files that are the validation target. Furthermore, the encoding XML definition file 133 is created by an encoding processing unit 122 in the validation unit 120, which will be described later.

The analysis unit 110 includes an internal memory that stores therein control data and programs in which various kinds of procedures are prescribed, whereby the analysis unit 110 performs various kinds of processes. Furthermore, the analysis unit 110 corresponds to, for example, an electronic circuit in an integrated circuit, such as an application specific integrated circuit (ASIC), a field programmable gate array (FPGA), or the like. Alternatively, the analysis unit 110 corresponds to an electronic circuit, such as a central processing unit (CPU), a micro processing unit (MPU), or the like. The analysis unit 110 includes a lexical analysis unit 111, an encoding processing unit 112, and an index creating unit 113. Furthermore, the lexical analysis unit 111, the encoding processing unit 112, and the index creating unit 113 are an example of a second creating unit.

The lexical analysis unit 111 performs, for each tag, a lexical analysis on the XML schema. The lexical analysis mentioned here indicates that a character string indicated by a tag is divided into tag names or definition values. For example, the lexical analysis unit 111 sequentially reads tags from the top of the XML schema. Namely, the lexical analysis unit 111 reads tags indicating a character string that starts from the start symbol “<” and that ends by the end symbol “>”. Then, the lexical analysis unit 111 performs the lexical analysis on the read tags.

The encoding processing unit 112 encodes the tag names or the definition values. For example, the encoding processing unit 112 encodes a tag name output from the lexical analysis unit 111 to a sign code by using the encoding dictionary 131. Furthermore, the encoding processing unit 112 encodes a definition value output from the lexical analysis unit 111 to a sign code by using the encoding dictionary 131.

The index creating unit 113 creates, regarding each of the tags and the definition values included in the XML schema, an inverted index 132 that is used to store therein an appearance position of each of the tags and the definition values. Furthermore, a single appearance position is not always associated with a single tag but also associated with a plurality of tags, even if a plurality of tags is present, if the tags are units of the same meaning in XML. For example, regarding the tag name and the definition value included in the tag, the index creating unit 113 sets a bit at the appearance position in the inverted index 132 associated with the appearance position in the XML schema. As an example, regarding the tag name in the tag area, the index creating unit 113 sets, in a case of a tag name, ON at the appearance position in the inverted index 132 associated with the appearance position in the XML schema. In a case of a definition value, regarding the definition value in the rule area, the index creating unit 113 sets ON at the appearance position in the inverted index 132 associated with the appearance position in the XML schema. Furthermore, if the subject tag name is not present in the tag area, the index creating unit 113 adds a tag name and a sign code associated with the tag name to the tag area; adds the index associated with this tag name; and then sets a bit at the appearance position. Furthermore, regarding the rule area, the index creating unit 113 previously adds a definition value and a sign code that is allocated to the definition value and then sets a bit at the appearance position at the time of appearance.

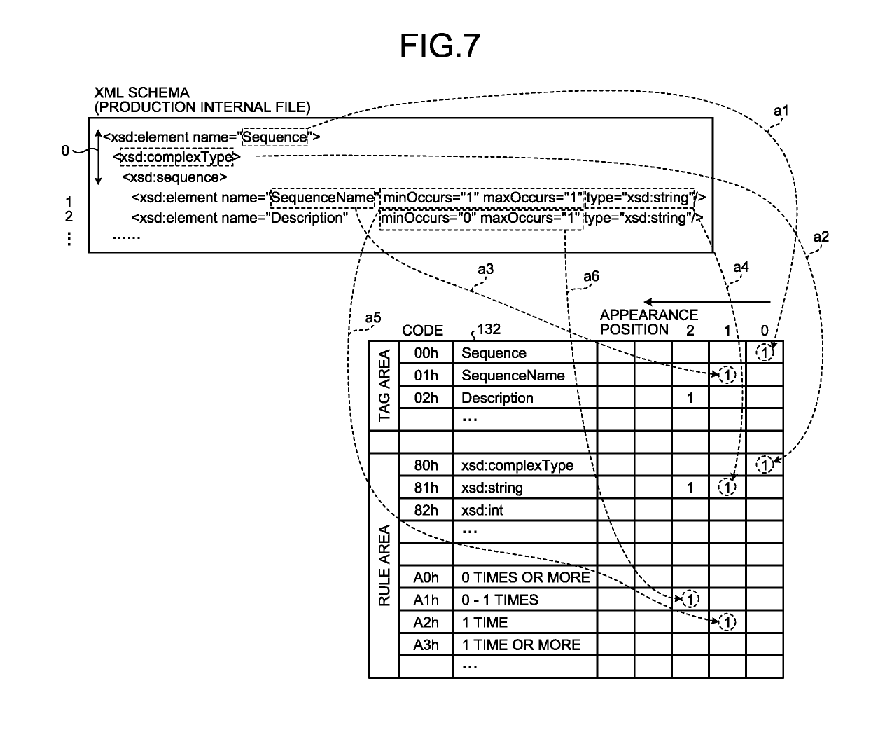

In the following, an example of the flow of an index creating process according to the embodiment will be described with reference to FIG. 7. FIG. 7 is a diagram illustrating the flow of an index creating process according to the embodiment.

First, it is assumed that the lexical analysis unit 111 has read the tags from the top. Here, it is assumed that <xsd:element name=“Sequence”> has been read. As illustrated in FIG. 7, because the tag type of the read tag is the start tag and is “element”, the index creating unit 113 sets, regarding the read tag name, “1” to the appearance position in the inverted index 132 associated with the appearance position in the XML schema (a1). Here, with respect to the tag name “Sequence” in the tag area, an appearance bit “1” is set to the appearance position of “0” in the inverted index 132 that is associated with the appearance position “0” in the XML schema. Furthermore, if the tag name “Sequence” is not present in the tag area, first, the index creating unit 113 adds, to the tag area, the tag name and the sign code that was obtained by encoding the tag name by the encoding processing unit 112 and then sets an appearance bit to the appearance position.

Then, it is assumed that the lexical analysis unit 111 has read the subsequent tag. Here, it is assumed that <xsd:complexType> has been read. Because the tag type of the read tag is the start tag and is “complexType”, the index creating unit 113 sets, regarding the read “complexType”, “1” to the appearance position in the inverted index 132 that is associated with the appearance position in the XML schema (a2). Here, regarding the tag name “complexType” in the tag area, the appearance bit “1” is set to the appearance position “0” in the inverted index 132 that is associated with the appearance position “0” in the XML schema. Furthermore, if the tag name “complexType” is not present in the tag area, first, the index creating unit 113 adds, to the tag area, the tag name and the sign code that was obtained by encoding the tag name by the encoding processing unit 112 and then sets an appearance bit to the appearance position.

Here, the appearance position of the tag name “complexType” is indicated by “0” that is the same as that indicated by the tag name “Sequence”. This is because both “complexType” and “Sequence” are units of the same meaning in XML. Namely, both “Sequence” and “complexType” are represented by different tags; however, because “complexType” indicates the property related to “Sequence”, both become units of the same meaning in XML. Thus, “complexType” and “Sequence” are represented at the same appearance position.

Then, it is assumed that the lexical analysis unit 111 has read the subsequent tag. Here, it is assumed that <xsd:element name=“SequenceName”minOccurs=“1”maxOccurs=“1”type=“xsd:string”/> has been read. Because the tag type of the read tag is a single tag and “element name”, the index creating unit 113 sets, regarding the tag name, “1” to the appearance position in the inverted index 132 that is associated with the appearance position in the XML schema (a3). Here, regarding the tag name “SequenceName” in the tag area, the appearance bit “1” is set to the appearance position “1” in the inverted index 132 that is associated with the appearance position “1” in the XML schema.

In addition, regarding the number of appearances included in the tag and the data type, the index creating unit 113 sets “1” to the appearance position in the inverted index 132. Here, regarding “minOccurs=“1”maxOccurs=“1”” indicating the number of appearances, the appearance bit “1” is set, for “one time” in the rule area, to the appearance position “1” in the inverted index 132 that is associated with the appearance position “1” in the XML schema (a5). Regarding ““xsd:string”” indicating the data type, the appearance bit “1” is set, for “xsd:string” in the rule area, to the appearance position “1” in the inverted index 132 that is associated with the appearance position “1” in the XML schema (a4).

Furthermore, because “minOccurs=“0”maxOccurs=“1”” included in the tag that is present in the subsequent appearance position indicates that the number of appearances is zero or one time, the appearance bit “1” is set in the inverted index 132 that is associated with “zero or one time” in the rule area (a6).

In this way, the index creating unit 113 creates the inverted index 132 from the sequentially read tags by using the encoding dictionary 131.

A description will be given here by referring back to FIG. 3. The validation unit 120 includes an internal memory that stores therein control data and programs in which various kinds of procedures are prescribed, whereby the validation unit 120 performs various kinds of processes. Furthermore, the validation unit 120 corresponds to, for example, an electronic circuit in an integrated circuit, such as an application specific integrated circuit (ASIC), a field programmable gate array (FPGA), or the like. Alternatively, the validation unit 120 corresponds to an electronic circuit, such as a central processing unit (CPU), a micro processing unit (MPU), or the like. The validation unit 120 includes a lexical analysis unit 121, the encoding processing unit 122, and a schema validation unit 123. Furthermore, the lexical analysis unit 121 and the encoding processing unit 122 are an example of a first creating unit. The schema validation unit 123 is an example of a validation unit.

The lexical analysis unit 121 performs a lexical analysis on a plurality of XML definition files. The lexical analysis mentioned here indicates that character strings included in the plurality of XML definition files are divided into tag names or definition values. Then, the lexical analysis unit 121 sequentially outputs the tag names or the definition values that are the results of the lexical analysis to the encoding processing unit 122.

The encoding processing unit 122 encodes the tag names or the definition values. For example, the encoding processing unit 122 encodes the tag name output from the lexical analysis unit 121 to a sign code by using the encoding dictionary 131. Furthermore, the encoding processing unit 122 encodes the definition value output from the lexical analysis unit 121 to a sign code by using the encoding dictionary 131. Then, the encoding processing unit 122 creates the encoding XML definition file 133 in which each of the plurality of XML definition files has been encoded.

The schema validation unit 123 validates the encoding XML definition file 133 by using the inverted index 132.

For example, the schema validation unit 123 sequentially reads a sign code for each byte from the encoding XML definition file 133. The schema validation unit 123 judges the code type of the read sign code. The code type mentioned here indicates the type of code indicating whether, for example, the code is a code with 1 byte or a code with 2 bytes. If the schema validation unit 123 judges that the code type is the code type of 1 byte, the schema validation unit 123 further judges whether the tag type is the start tag. Furthermore, a judgement of whether the code type of the sign code is the code type of 1 byte can be determined by referring to the encoding dictionary 131. A judgement of whether the tag type of the sign code is the start tag can be determined whether the sign code is “00h” to “3Fh”, in a case where the code of the start tag is defined to be “00h” to “3Fh”.

If the schema validation unit 123 judges that the tag type of the read sign code is the start tag, the schema validation unit 123 performs the following process.

If a stack is empty, the schema validation unit 123 pushes the end tag associated with the own start tag onto the top level. The “stack” mentioned here holds elements in the data structure of Last In First Out (LIFO) and holds the end tag associated with the start tag that is being validated. It is assumed that the rule to be validated is associated with the held elements. Then, if the own start tag is complexType, the schema validation unit 123 refers to the inverted index 132 and associates, with the top level element, the element (the tag in the tag area and the rule in the rule area) that is present between the own start tag and the end tag and in which the appearance bit is set. This is because the own start tag is complexType and is the element (complex type) having a child element. If the own start tag is not complexType, the schema validation unit 123 associates the type, such as the data type, of the own start tag with the top level element.

If the stack is not empty, the schema validation unit 123 refers to the inverted index 132 in a case where the type of the top level element in the stack is complexType and then judges whether the own start tag appears first before the top level element appears. If the own start tag appears first before the top level element appears in the stack, the schema validation unit 123 judges the position of the own start tag is valid and performs validation by using the element associated with the top level element in the stack. If the validation has been successful, the schema validation unit 123 update, regarding the own start tag, the element associated with the top level element in the stack. As an example, the schema validation unit 123 deletes the element that has successfully been validated from among elements associated with the top level element in the stack. Then, the schema validation unit 123 pushes the end tag associated with the own start tag onto the top level element in the stack. If the own start tag is complexType, the schema validation unit 123 refers to the inverted index 132 and associates, with the top level element in the stack, the element (the tag in the tag area and the rule in the rule area) that is present between the start tag and the end tag and in which the appearance bit is set. This is because the own start tag is complexType and is the element (complex type) having a child element. If the own start tag is not complexType, the schema validation unit 123 associates the type, such as the data type, of the own start tag with the top level element.

If the schema validation unit 123 judges that the tag type of the read sign code is the end tag, the schema validation unit 123 performs the following process. The schema validation unit 123 checks the sign code of the own end tag against the sign code of the top level element in the stack and judges that, if the sign codes match, the position of the own end tag is valid and performs validation the own end tag based on the type of the top level element in the stack.

If the schema validation unit 123 judges that the code type of the read sign code is the code type of 2 bytes or 3 bytes, the schema validation unit 123 performs the following process. The schema validation unit 123 reads the rest of the sign codes having the number of bytes from the encoding XML definition file 133. If the type of the read sign codes having 2 or 3 bytes match the type of the top level element in the stack, the schema validation unit 123 determines the validation of the own 2- or 3-byte code is valid and updates the status of the type associated with the top level element in the stack to “validated”. If the read sign codes having 2 or 3 bytes do not match the type of the top level element in the stack, the schema validation unit 123 determines the validation of the own 2- or 3-byte code is abnormal. Furthermore, the type of the sign codes of 2 and 3 bytes may be determined by the data type associated with, for example, the coding region in the encoding dictionary 131.

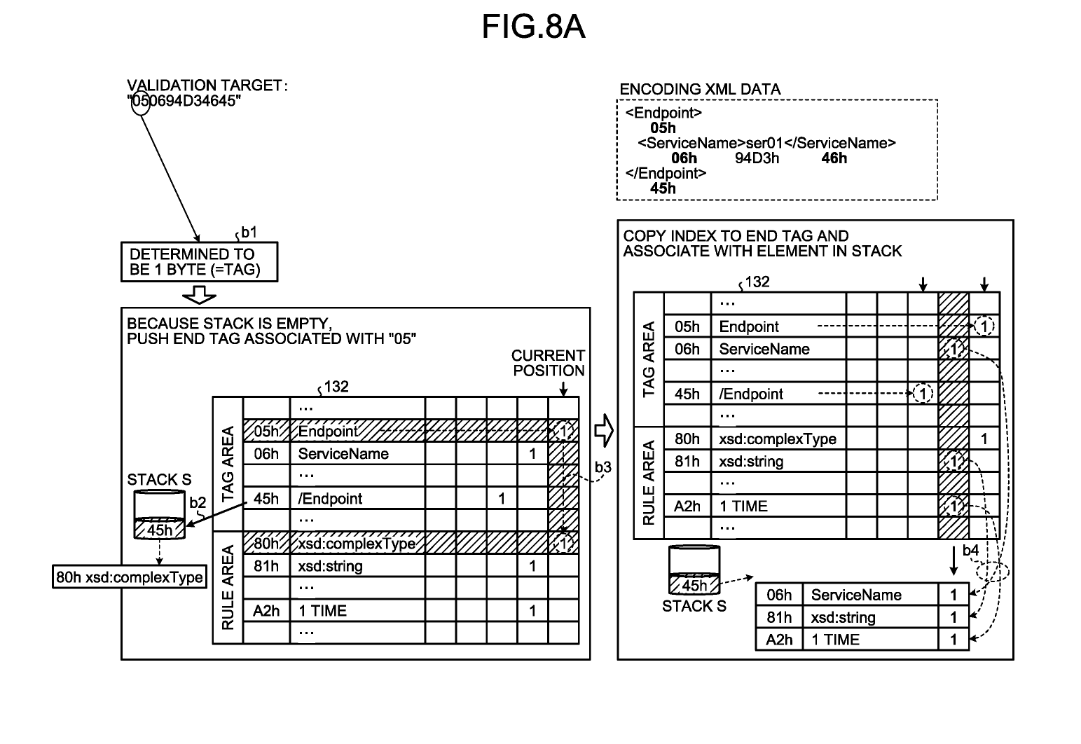

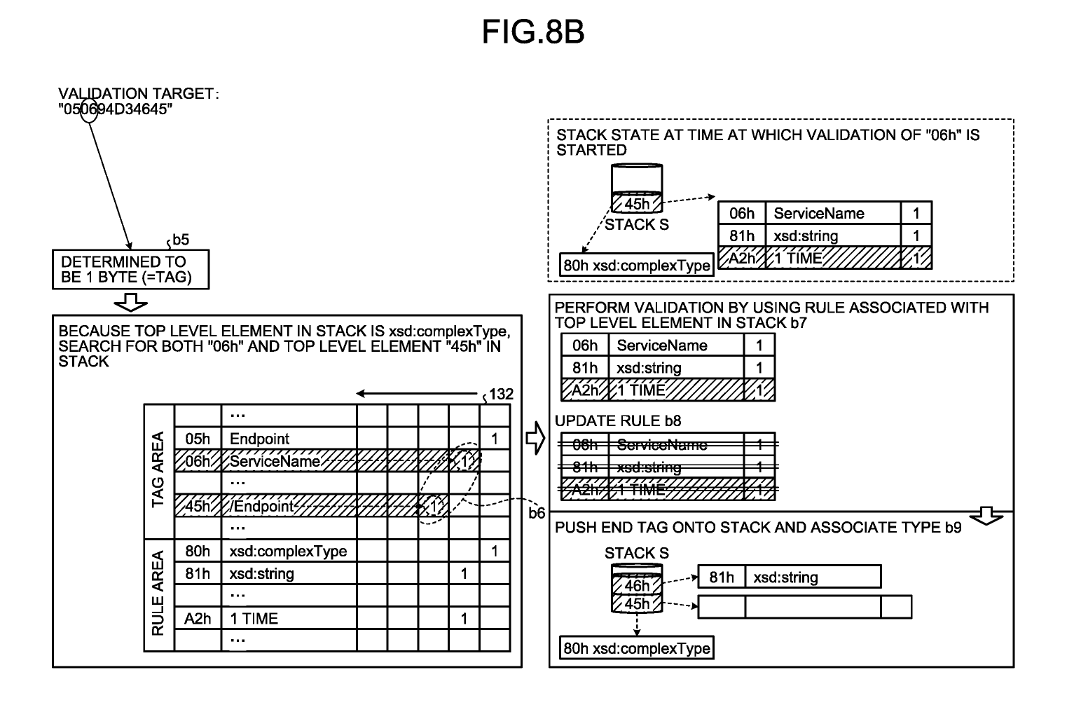

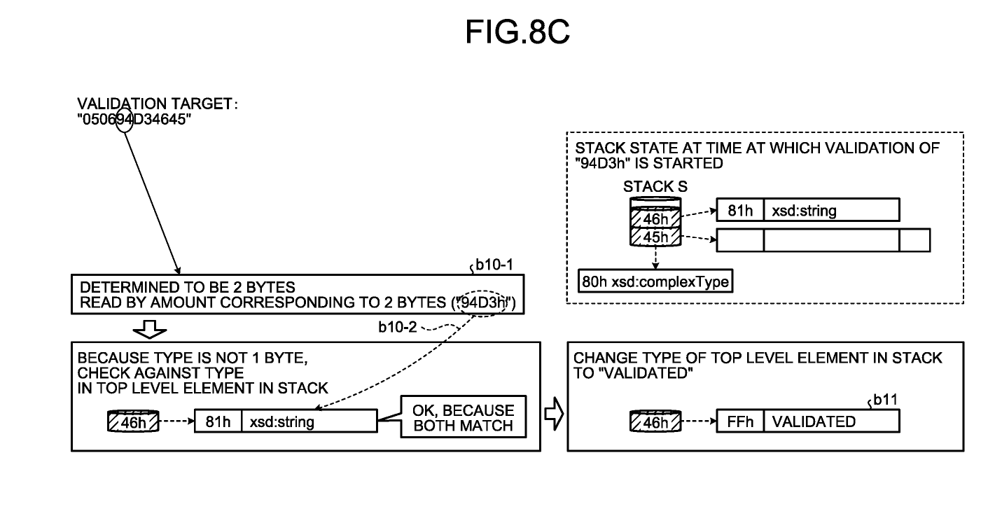

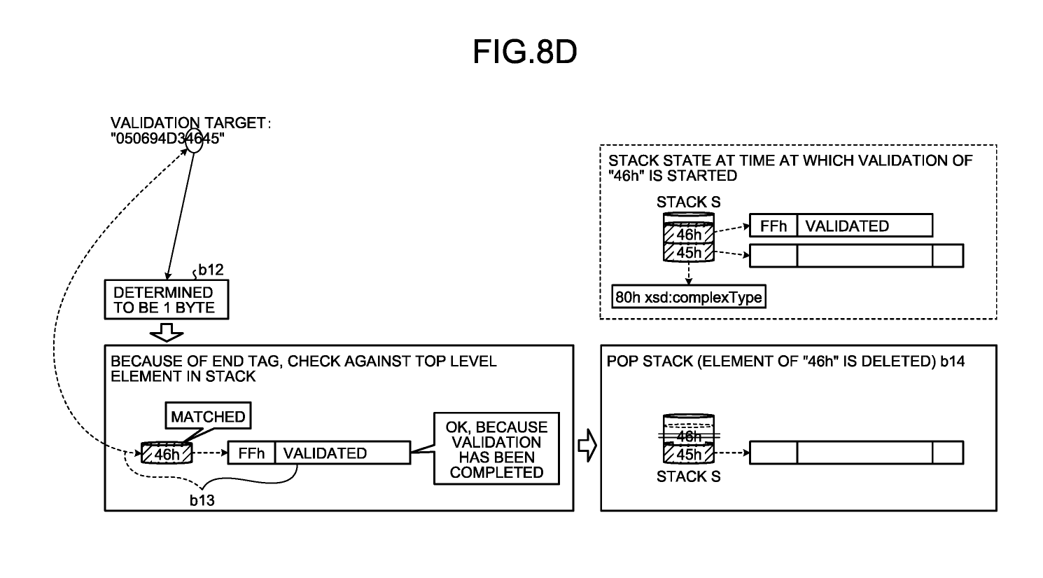

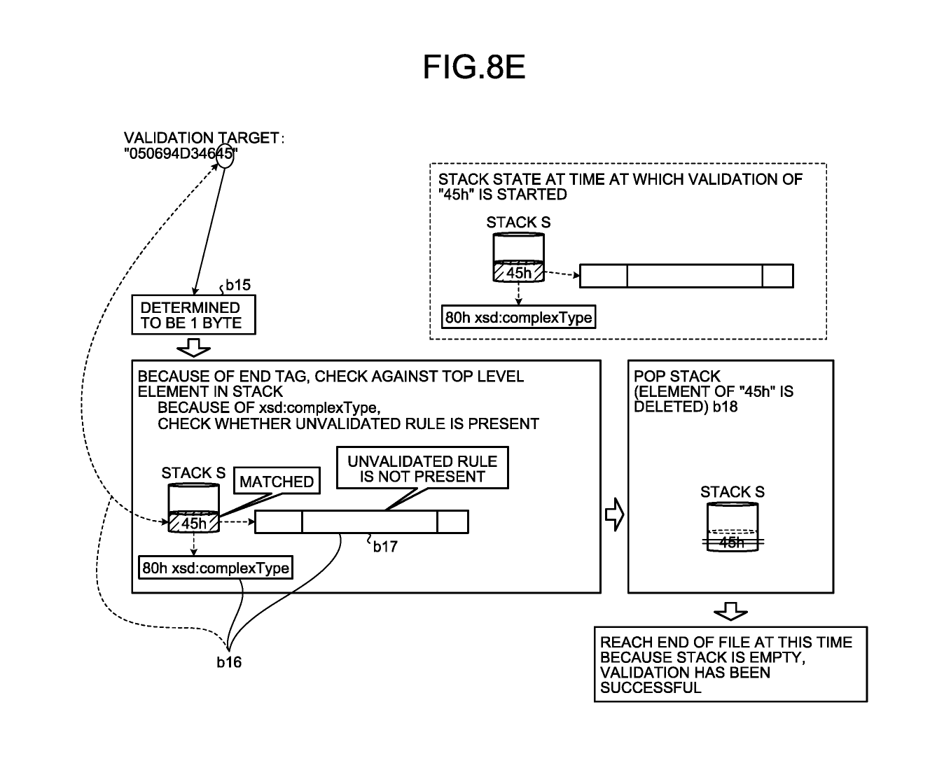

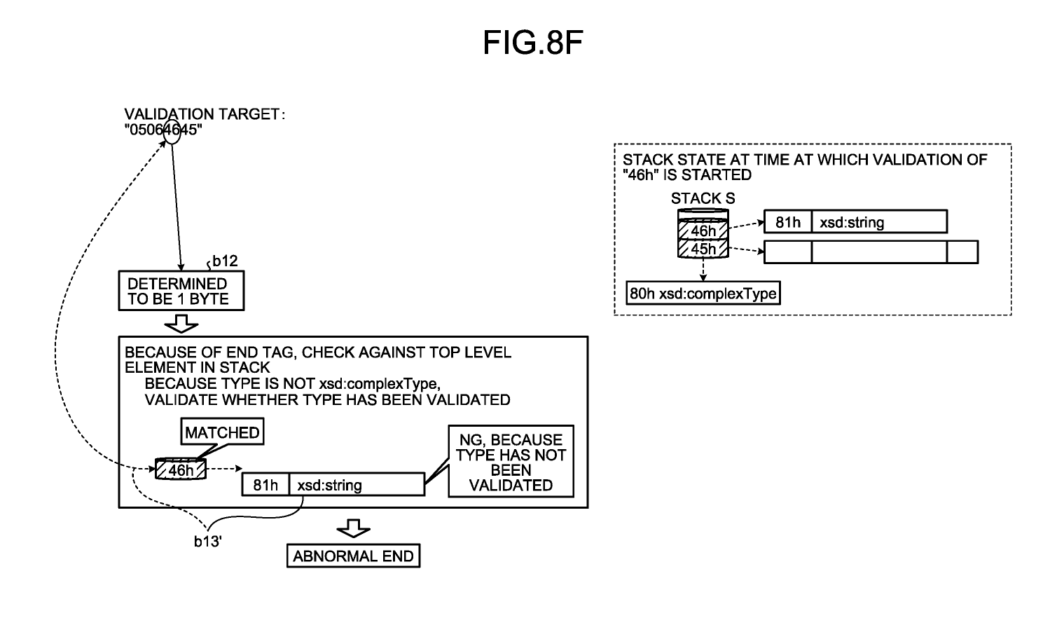

In the following, an example of the flow of the schema validation process according to the embodiment will be described with reference to FIG. 8A to FIG. 8F. FIG. 8A to FIG. 8F are diagrams each illustrating the flow of a schema validation process according to the embodiment. Furthermore, in FIG. 8A to FIG. 8F, it is assumed that “050694D34645” has been set as a sign code group in the encoding XML definition file 133 that is a validation target.

As illustrated in FIG. 8A, the schema validation unit 123 reads 1 byte from the top of the validation target. Here, it is assumed that the read 1 byte is “05h”. The schema validation unit 123 refers to the encoding dictionary 131 and judges that the sign code with the read 1 byte is a high frequency keyword and is the code type of 1 byte (b1). Furthermore, the schema validation unit 123 refers to the encoding dictionary 131 and judges that the sign code with the read 1 byte is “00h” to “3Fh” and the tag type is the start tag.

Because the tag type of the sign code with the read 1 byte is the start tag, the schema validation unit 123 performs the following process. Because an element has not been held in a stack S (empty), the schema validation unit 123 pushes the end tag associated with the start tag onto the stack S (b2). Here, because the sign code with the read 1 byte is “05h”, the schema validation unit 123 pushes “45h”, as the end tag, that is obtained by adding “05h” to “40h” onto the stack S.

The schema validation unit 123 refers to the inverted index 132 and judges that the own start tag is complexType (b3). Thus, the schema validation unit 123 associates the data indicating that the own start tag is complexType with the end tag that is associated with the own start tag. Here, as an example, the information indicating that the own start tag “05h” is complexType is associated with the end tag “45h” that has been pushed onto the stack S.

Because the own start tag is complexType, the schema validation unit 123 refers to the inverted index 132 and associates the region located between the own start tag and the end tag with the top level element in the stack S (b4). Namely, the schema validation unit 123 associates the element (the tag in the tag area and the rule in the rule area) that is located between the own start tag and the end tag and in which the appearance bit is set with the top level element in the stack S. Here, the tag “06h” in the tag area and both “81h” and “A2h” in the rule area are associated with the top level element “45h” in the stack S as the region located between the start tag and the end tag. “06h” is the sign code of the tag of “ServiceName”. “81h” is the sign code of the rule of “xsd:string” as the data type. “A2h” is the sign code of the rule of “one time” as the number of appearances.

As illustrated in FIG. 8B, the schema validation unit 123 reads the subsequent 1 byte from the validation target. Here, it is assumed that the read 1 byte is “06h”. The schema validation unit 123 refers to the encoding dictionary 131 and judges that the sign code of the read 1 byte is a high frequency keyword and is the code type of 1 byte (b5). Furthermore, the schema validation unit 123 refers to the encoding dictionary 131 and judges the sign code of the read 1 byte is “00h” to “3Fh” and the tag type is the start tag.

Because the tag type of the sign code of the read 1 byte is the start tag, the schema validation unit 123 performs the following process. Because the element has already been held in the stack S and the type of the top level element in the stack S is complexType, the schema validation unit 123 searches for both the appearance position of the own start tag and the appearance position of the top level element in the stack S (b6). Here, because the own start tag “06h” appears first before the top level element “45h”, the schema validation unit 123 determines that the position of the own start tag “06h” in the validation target is valid.

Furthermore, the schema validation unit 123 validates the own start tag by using the element associated with the top level element in the stack S (b7). Here, if the element associated with the top level element in the stack S is used, the own start tag “06h” can appear “one time”; therefore, the schema validation unit 123 determines that the number of appearances of the own start tag “06h” of “one time” is valid.

Thus, the schema validation unit 123 updates, regarding the own start tag, the element associated with the top level element in the stack S (b8). Here, the schema validation unit 123 updates, from among the elements associated with the top level element in the stack S, the row of the element “06h” that has successfully been validated. In the example indicated by b8 illustrated in FIG. 8B, because the validation target is only A2h (one time), the validation of “06h” has been completed here and then “06h”, “81h”, and “A2h” that are the elements related to the row of 06h are deleted.

Then, the schema validation unit 123 pushes the end tag associated with the own start tag onto the top level element in the stack S. In addition, because the start tag is not complexType, the schema validation unit 123 associates the type of the own start tag with the top level element in the stack S (b9). Here, the schema validation unit 123 pushes “46h”, as the end tag, that is obtained by adding “40h” to the own start tag “06h” onto the stack S. The schema validation unit 123 associates “81h” (character string type), as the type of the own start tag “06h”, with the top level element “46h” in the stack S.

As illustrated in FIG. 8C, the schema validation unit 123 reads the subsequent 1 byte from the validation target. Here, it is assumed that the read 1 byte is “94h”. Because the schema validation unit 123 refers to the encoding dictionary 131 and judges that the read 1 byte “94h” is the code type of 2 bytes, the schema validation unit 123 reads an amount corresponding to 2 bytes (b10-1). It is assumed that the read 2 bytes are “94D3h”.

The schema validation unit 123 checks the type of the sign code of the read 2 bytes against the type of the top level element in the stack S and determines that, if both types match, the validation of the own sign code with 2 bytes is valid (b10-2). Here, because it is found that the type of the own sign code “94D3h” with 2 bytes is the character string type based on the encoding dictionary 131, this matches the type “xsd:string” of the top level element in the stack S. Thus, the schema validation unit 123 determines that the validation of the own sign code “94D3h” of 2 bytes is valid.

Then, the schema validation unit 123 changes, if both match, the status of the type associated with the top level element in the stack S to “validated” (b11).

As illustrated in FIG. 8D, the schema validation unit 123 reads the subsequent 1 byte from the validation target. Here, it is assumed that the read 1 byte is “46h”. The schema validation unit 123 refers to the encoding dictionary 131 and judges that the sign code of the read 1 byte is a high frequency keyword and is the code type of 1 byte (b12). Furthermore, the schema validation unit 123 refers to the encoding dictionary 131 and judges that the sign code of the read 1 byte is “40h” to “7Fh” and the tag type is the end tag.

The schema validation unit 123 checks the sign code of the own end tag against the sign code of the top level element in the stack S and judges whether, if both match, the type of the top level element in the stack S is ComplexType, “validated”, or other than these (b13). Here, because both the sign code of the own end tag and the sign code of the top level element in the stack S are “46h”, the check is matched. Then, the type of the top level element in the stack S is not ComplexType but “validated”. Thus, the schema validation unit 123 determines that the validation of the own end tag is valid.

The schema validation unit 123 pops the top level element in the stack S (b14). Consequently, the top level element (sign code “46h”) in the stack S is deleted. Then, the top level element in the stack S becomes the sign code “45h”.

As illustrated in FIG. 8E, the schema validation unit 123 reads the subsequent 1 byte from the validation target. Here, it is assumed that the read 1 byte is “45h”. The schema validation unit 123 refers to the encoding dictionary 131 and judges that the sign code of the read 1 byte is a high frequency keyword and is the code type of 1 byte (b15). Furthermore, the schema validation unit 123 refers to the encoding dictionary 131 and judges that the sign code of the read 1 byte is “40h” to “7Fh” and the tag type is the end tag.

The schema validation unit 123 checks the sign code of the own end tag against the sign code of the top level element in the stack S and judges, if both match, the type of the top level element in the stack S is ComplexType, “validated”, or other than these (b16). Here, because both the sign code of the own end tag and the sign code of the top level element in the stack S are “45h”, the both match. Then, the type of the top level element in the stack S is ComplexType. Thus, the schema validation unit 123 judges whether the rule that has not been validated (unvalidated rule) is associated with the top level element in the stack S (b17). Here, the unvalidated rule is not associated with the top level element in the stack S. Thus, the schema validation unit 123 determines that the validation of the own end tag is valid.

The schema validation unit 123 pops the top level element in the stack S (b18). Consequently, the top level element (sign code “45h”) in the stack S is deleted.

The schema validation unit 123 reaches the end of the encoding XML definition file 133 at this time and judges that the validation has been successful because the stack S is empty.

FIG. 8F is a diagram illustrating an example of the flow of the schema validation process in a case of abnormal end associated with FIG. 8D.

As illustrated in FIG. 8F, the schema validation unit 123 reads the subsequent 1 byte “46h” from the validation target and judges that the read 1 byte is the code type of 1 byte (b12). Furthermore, the schema validation unit 123 refers to the encoding dictionary 131 and judges that the sign code of the read 1 byte is “40h” to “7Fh” and the tag type is the end tag.

The schema validation unit 123 checks the sign code of the own end tag against the sign code of the top level element in the stack S and judges whether, if both match, the type of the top level element in the stack S is ComplexType, “validated”, or other than these (b13′). Here, because both the sign code of the own an end tag and the sign code of the top level element in the stack S are “46h”, the both match. Furthermore, the type of the top level element in the stack S is neither ComplexType nor “validated”, and is other than these. Thus, the schema validation unit 123 judges that the validation of the own end tag is not valid. Namely, the schema validation unit 123 judges that the schema validation process is an abnormal end.

Flowchart of the Index Creating Process

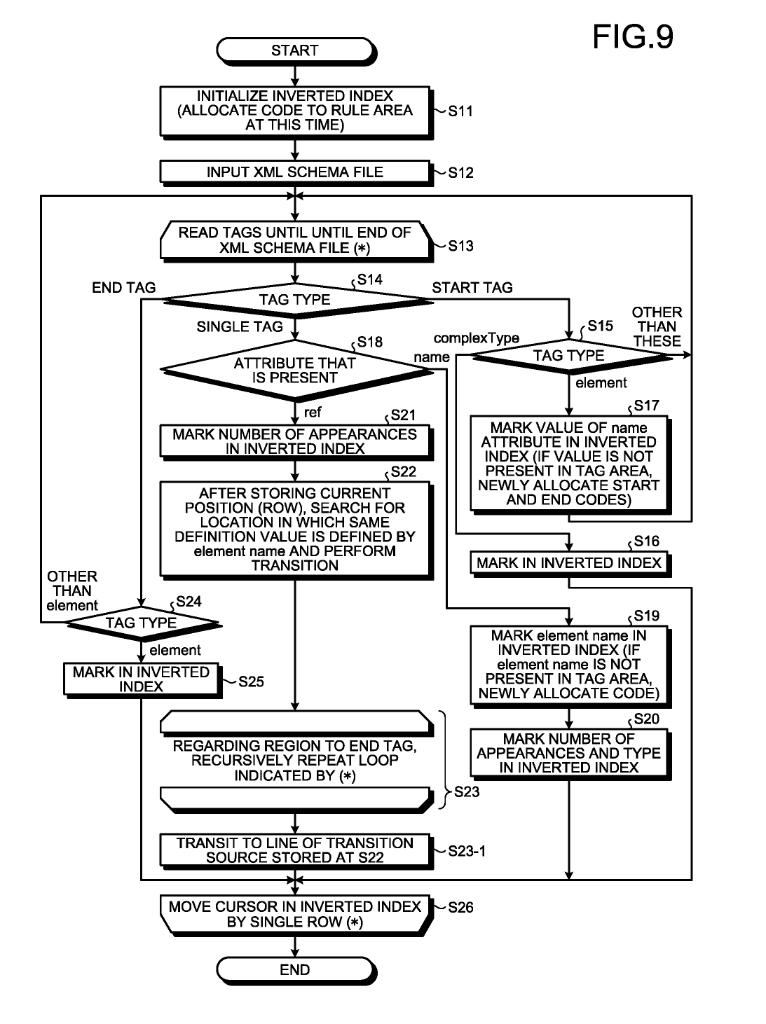

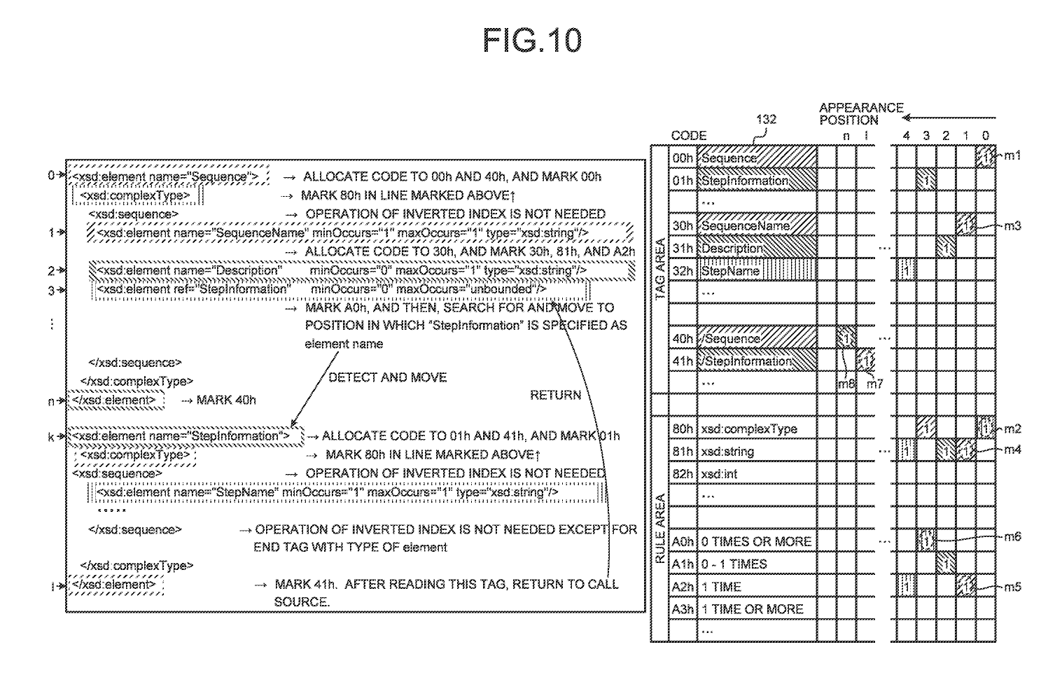

FIG. 9 is a diagram illustrating an example of the flowchart of the index creating process according to the embodiment. Furthermore, in the following, a description will be given by appropriately using the XML schema and the inverted index 132 illustrated in FIG. 10.

As illustrated in FIG. 9, the index creating unit 113 initializes the inverted index 132 (Step S11). Furthermore, at this time, the index creating unit 113 allocates the sign code to the definition value in the rule area in the inverted index 132.

The index creating unit 113 inputs the XML schema file (Step S12). The index creating unit 113 sequentially reads the tags from the XML schema file until when the index creating unit 113 reaches the end of the XML schema file (Step S13).

The index creating unit 113 determines whether the tag type is the start tag, the end tag, or a single tag (Step S14). If it is determined that the tag type is the start tag (Step S14; the start tag), the index creating unit 113 determines whether the tag type is complexType, element, or other than these (Step S15).

At Step S15, if it is determined that the tag type is element (element at Step S15), the index creating unit 113 marks the value of the name attribute in the inverted index 132 (Step S17). Furthermore, if the value of the name attribute is not present in the tag area in the inverted index 132, the index creating unit 113 allocates, via the encoding processing unit 112, the sign code of each of the start tag and the end tag associated with the value of the name attribute. Here, in FIG. 10, for example, if the tag of <xsd:element name=“Sequence”> has been read, this tag is the start tag and the tag type is element; therefore, the following process is performed. The index creating unit 113 allocates the sign codes of the start tag and the end tag with respect to the value “Sequence” of the name attribute to “00h” and “40h”, respectively, and adds them to the tag area. The index creating unit 113 marks, regarding the inverted index 132, the appearance bit “1” to the bit at the location of the appearance position indicated by “0” and the sign code indicated by “00h” (m1). Then, the index creating unit 113 moves to Step S13 in order to read the subsequent tag.

At Step S15, if it is determined that the tag type is complexType (complexType at Step S15), the index creating unit 113 marks, in the inverted index 132, that the tag type is complexType (Step S16). Here, in FIG. 10, for example, if the tag of <xsd:complexType> has been read, this tag is the start tag and the tag type is complexType; therefore, the following process is performed. The index creating unit 113 marks, regarding the inverted index 132, the appearance bit “1” to the bit at the location of the appearance position indicated by “0” and the sign code of complexType indicated by “80h” (m2). The appearance position is indicated by “0” that is the same as that indicated by “Sequence”. This is because both “Sequence” and “complexType” are represented by different tags; however, both are units of the same meaning in XML. Then, the index creating unit 113 moves to Step S26 in order to move a cursor of the appearance position forward in the inverted index 132 by a single row.

At Step S15, if it is determined that the tag type is other than these (other than these at Step S15), the index creating unit 113 does not process anything. Here, in FIG. 10, for example, if the tag of <xsd:sequence> has been read, this tag is the start tag and the tag type is neither element nor complexType; therefore, the index creating unit 113 does not process anything. Then, the index creating unit 113 moves to Step S13 in order to read the subsequent tag.

At Step S14, if it is determined that the tag type is a single tag (Step S14; single tag), the index creating unit 113 judges whether the attribute of the tag (a synonym for the attribute of XML, the same applies hereinafter) is “name” or “ref” (Step S18).

At Step S18, if it is judged that the attribute of the tag is “name” (name at Step S16), the index creating unit 113 marks the element name in the inverted index 132 (Step S19). Furthermore, if the element name is not present in the tag area in the inverted index 132, the index creating unit 113 allocates, via the encoding processing unit 112, the sign codes of the start tag and the end tag with respect to the element name. Here, in FIG. 10, for example, it is assumed that the tag of <xsd:element name=“SequenceName”minOccurs=“1”maxOccurs=“1”type=“xsd:string”/> has been read. In such a case, this tag is a single tag and the attribute of the tag is name; therefore, the following process is performed. The index creating unit 113 allocates the sign code “30h” of the single tag with respect to the value “SequenceName” of the name attribute and adds it to the tag area. The index creating unit 113 marks, regarding the inverted index 132, the appearance bit “1” to the bit at the location of the appearance position indicated by “1” and the sign code indicated by “30h” (m1).

Furthermore, the index creating unit 113 marks the number of appearances and the type in the inverted index 132 (Step S20). Here, in FIG. 10, “minOccurs=“1”maxOccurs=“1”type=”xsd:string“” is included in the tag. The index creating unit 113 marks, regarding the inverted index 132, the appearance bit “1” to the bit at the location of the appearance position indicated by “1” and the sign code of the number of appearances of “one time” indicated by “A2h” (m5). The index creating unit 113 marks, regarding the inverted index 132, the appearance bit “1” to the bit at the location of the appearance position indicated by “1” and the sign code of the type “xsd:string” indicated by “81h” (m4). Then, the index creating unit 113 moves to Step S26 in order to move a cursor of the appearance position forward in the inverted index 132 by a single row.

At Step S18, if it is determined that the attribute of the tag is ref (ref at Step S18), the index creating unit 113 marks the number of appearances in the inverted index 132 (Step S21). Here, in FIG. 10, for example, it is assumed that the tag of <xsd:element ref=“StepInformation”minOccurs=“0”maxOccurs=“unbounded”/> has been read. In such a case, this tag is a single tag and the attribute of the tag is ref; therefore, the following process is performed. “minOccurs=“0”maxOccurs=“unbounded”” is included in the tag. The index creating unit 113 marks, regarding the inverted index 132, the appearance bit “1” to the bit at the location of the appearance position indicated by “3” and the sign code of the number of appearances of “0 time or more” indicated by “A0h” (m6).

Furthermore, the index creating unit 113 stores the current row, searches for the location in which the same definition value is defined by the element name, and performs transition to the line in the XML schema file (Step S22). Here, in FIG. 10, for example, the start tag indicating “StepInformation” is found as the definition value at the position of the appearance position indicated by k. The index creating unit 113 moves the line to the position of the tag of <xsd:element name=“StepInformation”>.

Then, regarding the region from the start tag of the position of the appearance position indicated by k to the end tag of the appearance position indicated by 1, the index creating unit 113 recursively repeats the loop of Steps S13 to S26 (Step S23). The index creating unit 113 moves to the line of the transition source stored at Step S22 (Step S23-1). Then, the index creating unit 113 moves to Step S26 in order to move a cursor of the appearance position forward in the inverted index 132 by a single row.

At Step S14, if it is judged that the tag type is the end tag (the end tag at Step S14), the index creating unit 113 determines whether the tag type is the element or other than the element (Step S24).

At Step S24, if it is determined that the tag type is element (element at Step S24), the index creating unit 113 marks information indicating that the tag type is the end tag in the inverted index 132 (Step S25).

Here, in FIG. 10, as an example, if the tag of </xsd:element> has been read at the position of the appearance position indicated by 1, this tag is the end tag and the tag type is element; therefore, the following process is performed. The index creating unit 113 marks, regarding the inverted index 132, the appearance bit “1” to the bit at the location of the appearance position indicated by “1” and the sign code of the end tag indicated by “41h” (m7). Then, the position of the line in the XML schema file is returned to the call source (ref).

Furthermore, as another example, if the tag of </xsd:element> has been read at the position of the appearance position indicated by n, this tag is the end tag and the tag type is the element; therefore, the following process is performed. The index creating unit 113 marks, regarding the inverted index 132, the appearance bit “1” to the bit at the location of the appearance position indicated by “n” and the sign code of the end tag indicated by “40h” (m8).

Then, the index creating unit 113 moves to Step S26 in order to move a cursor of the appearance position forward in the inverted index 132 by a single row.

At Step S24, if it is determined that the tag type is not the element (other than the element at Step S24), the index creating unit 113 does not process anything. Here, in FIG. 10, for example, if the tag of </xsd:sequence> has been read, this tag is the end tag and the tag type is not the element; therefore, the index creating unit 113 does not process anything. Then, the index creating unit 113 moves to Step S13 in order to read the subsequent tag.

Then, at Step S13, if the index creating unit 113 reaches the end of the XML schema file, the index creating unit 113 ends the index creating process.

Flowchart of the Schema Validation Process

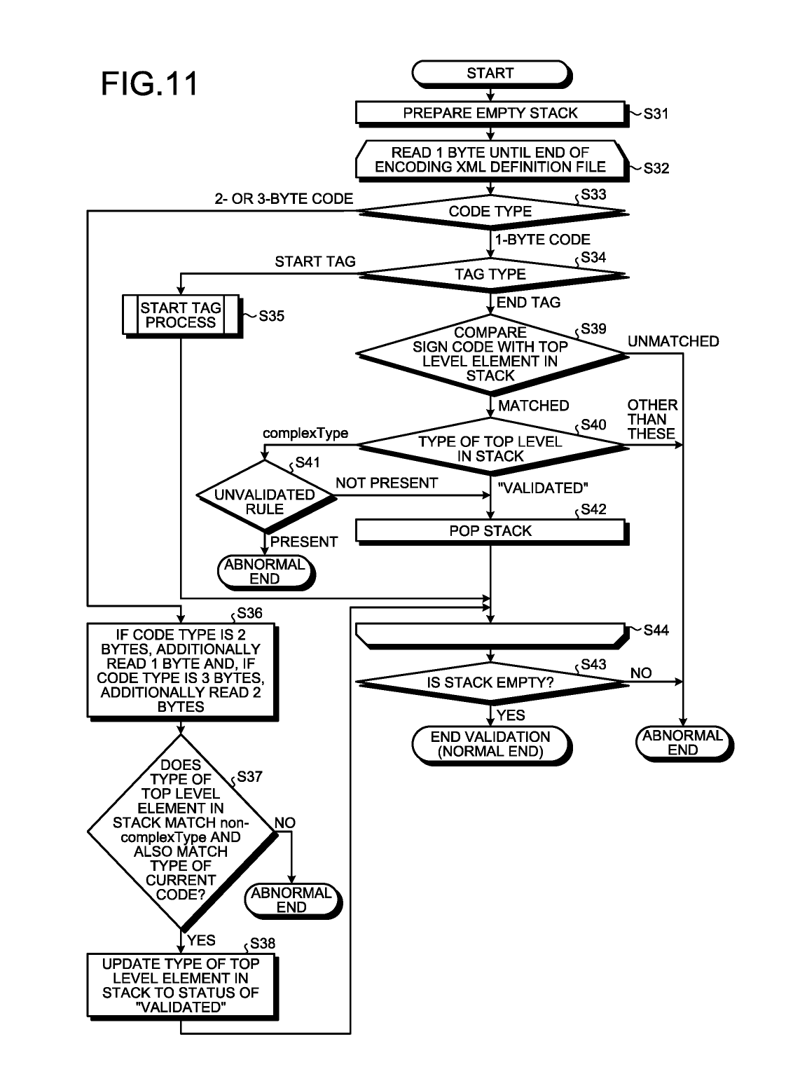

FIG. 11 is a diagram illustrating an example of the flowchart of the schema validation process according to the embodiment. Furthermore, it is assumed that the XML definition file has been subjected to an encoding process by the encoding processing unit 122 and is converted to the encoding XML definition file 133.

The schema validation unit 123 prepares the stack S, which is empty, in the storage unit 130 (Step S31). The schema validation unit 123 that has been received the encoding XML definition file 133 sequentially reads 1 byte until the schema validation unit 123 reaches the end of the encoding XML definition file 133 (Step S32).

The schema validation unit 123 that has been read 1 byte determines the code type of the sign code of the read 1 byte (Step S33). If it is determined that the code type is the code type of 1 byte (1 byte code at Step S33), the schema validation unit 123 determines the tag type (Step S34).

If it is determined that the tag type is the start tag (the start tag at Step S34), the schema validation unit 123 performs the start tag process (Step S35). Furthermore, the flowchart of the start tag process will be described later. Then, the schema validation unit 123 moves to Step S32 via Step S44 in order to read the subsequent 1 byte.

In contrast, it is determined that the tag type is the tag type is the end tag (the end tag at Step S34), the schema validation unit 123 compares the sign code of the subject end tag with the top level element in the stack S (Step S39). If the sign code of the end tag does not match the top level element in the stack S (unmatched at Step S39), the schema validation unit 123 determines that the XML definition file is abnormal and ends the schema validation process as an abnormal end.

If the sign code of the end tag matches the top level element in the stack S (Step S39; matched), the schema validation unit 123 determines the type of the top level element in the stack S (Step S40). If it is determined that the type of the top level element is “validated” (“validated” at Step S40), the schema validation unit 123 moves to Step S42 in order to pop the element from the stack S.

If it is determined that the type of the top level element is complexType (complexType at Step S40), the schema validation unit 123 determines whether an unvalidated rule is present (Step S41). If it is determined that an unvalidated rule is present (Step S41; present), the schema validation unit 123 determines that the XML definition file is abnormal and ends the schema validation process as an abnormal end.

In contrast, if it is determined that the unvalidated rule is not present (not present at Step S41), the schema validation unit 123 moves to Step S42 in order to pop the element in the stack S.

If the type of the top level element is neither complexType nor “validated” but is other than these (other than these at Step S40), the schema validation unit 123 determines that the XML definition file is abnormal and ends the schema validation process as an abnormal end.

At Step S42, the schema validation unit 123 pops the top level element in the stack S (Step S42). Then, the schema validation unit 123 moves to Step S32 via Step S44 in order to read the subsequent 1 byte.

At Step S33, if it is determined that the code type is the code type of 2 bytes or 3 bytes (2- or 3-byte code at Step S33), the schema validation unit 123 performs the following process (Step S36). The schema validation unit 123 additionally reads 1 byte in a case where the code type is 2 bytes. The schema validation unit 123 additionally reads 2 bytes in a case where the code type is 3 bytes.

Then, the schema validation unit 123 determines whether the type of the top level element in the stack S matches non-complexType and also matches the type of the current sign code (Step S37). If it is determined that both match (Yes at Step S37), the schema validation unit 123 updates the status of the type of the top level element in the stack S to “validated” (Step S38). Then, the schema validation unit 123 moves to Step S32 via Step S44 in order to read the subsequent 1 byte.

In contrast, if it is determined that both do not match (No at Step S37), the schema validation unit 123 determines that the XML definition file is abnormal and ends the schema validation process as an abnormal end.

After the end of the process at Step S44, the schema validation unit 123 determines whether the stack S is empty (Step S43). If it is determined that the stack S is empty, i.e., data is not present (Yes at Step S43), the schema validation unit 123 determines that the XML definition file is normal and ends the schema validation process as a normal end.

In contrast, if it is determined that the stack S is not empty, i.e., data is present (No at Step S43), the schema validation unit 123 determines that the XML definition file is abnormal and ends the schema validation process as an abnormal end.

Flowchart of the Start Tag Process

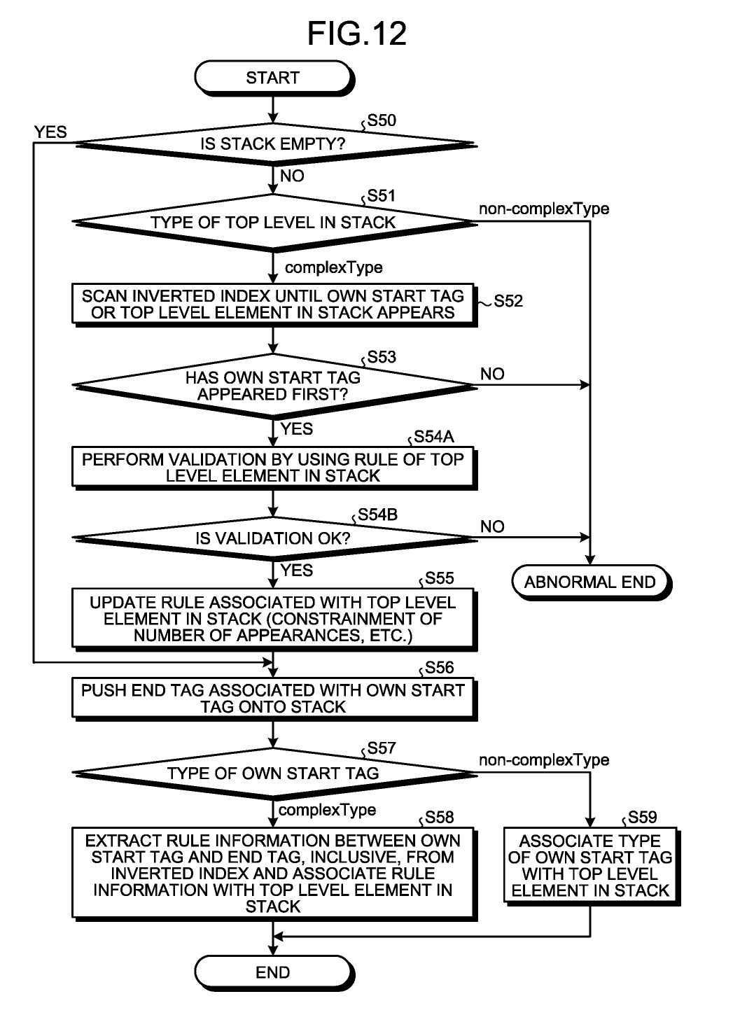

FIG. 12 is a diagram illustrating an example of the flowchart of a start tag process according to the embodiment.

As illustrated in FIG. 12, the schema validation unit 123 that has received the sign code of the start tag determines whether the stack S is empty (Step S50). Furthermore, hereinafter, the sign code of the start tag is sometimes abbreviated to the start tag. If it is determined that the stack S is empty (Yes at Step S50), the schema validation unit 123 moves to Step S56.

In contrast, if it is determined that the stack S is not empty (No at Step S50), the schema validation unit 123 determines the type of the top level element in the stack S (Step S51). If it is determined that the type of the top level element in the stack S is not complexType (non-complexType at Step S51), the schema validation unit 123 determines that the XML definition file is abnormal and ends the schema validation process as an abnormal end.

If it is determined that the type of the top level element in the stack S is complexType (complexType at Step S51), the schema validation unit 123 performs the following process. The schema validation unit 123 scans the inverted index 132 until the own start tag or the top level element in the stack S appears (Step S52).

The schema validation unit 123 determines whether the own start tag has appeared first (Step S53). If it is determined that the own start tag does not appear first (No at Step S53), the schema validation unit 123 determines that the XML definition file is abnormal and ends the schema validation process as an abnormal end.

In contrast, if it is determined that the own start tag appears first (Yes at Step S53), the schema validation unit 123 performs validation by using the rule of the top level element in the stack S (Step S54A). After the validation, the schema validation unit 123 determines whether the validation is OK (Step S54B). If it is determined that the validation is not OK (No at Step S54B), the schema validation unit 123 determines that the XML definition file is abnormal and ends the schema validation process as an abnormal end.

In contrast, if it is determined that the validation is OK (Yes at Step S54B), the schema validation unit 123 updates the rule associated with the top level element in the stack S (Step S55). Then, the schema validation unit 123 moves to Step S56.

At Step S56, the schema validation unit 123 pushes the end tag associated with the own start tag onto the stack S (Step S56). Then, the schema validation unit 123 judges the type of the own start tag (Step S57). If it is judged that the type of the own start tag is complexType (complexType at Step S57), the schema validation unit 123 performs the following process. The schema validation unit 123 extracts the rule information between the start tag and the end tag, inclusive, from the inverted index 132 and associates the rule information with the top level element in the stack S (Step S58). Then, the schema validation unit 123 ends the start tag process.

If it is determined that the type of the own start tag is not complexType (non-complexType at Step S57), the schema validation unit 123 performs the following process. The schema validation unit 123 associates the type of the own start tag with the top level element in the stack S (Step S59). Then, the schema validation unit 123 ends the start tag process.

Effect of the Embodiment

In this way, in the embodiment described above, the information processing apparatus 100 uses the encoding dictionary 131 in which a tag name or a definition value of each of a plurality of tags is associated with a code and creates the encoding XML definition file 133 by encoding a plurality of XML definition files that are validation target. The information processing apparatus 100 creates the inverted index 132 from the XML schemas associated with the plurality of XML definition files by using the encoding dictionary 131. Then, the information processing apparatus 100 validates the encoding XML definition file 133 by using the inverted index 132. With this configuration, the information processing apparatus 100 can perform a validation work at high speed by reading a schema for each XML definition file that is the validation target without performing validation.

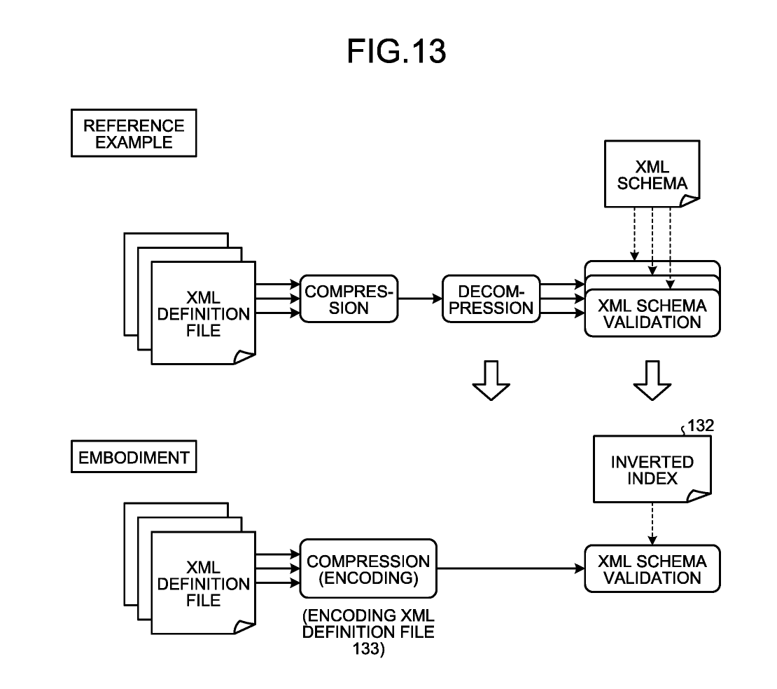

In the following, an example of the effect of XML schema validation according to the embodiment will be described with reference to FIG. 13. FIG. 13 is a diagram illustrating an example of the effect of the XML schema validation according to the embodiment. As illustrated in FIG. 13, when a plurality of XML definition files is compressed, a validation process used in the reference example decompresses compressed files at the time of XML schema validation. Then, the validation process reads XML schemas for each of the plurality of decompressed XML definition files and performs a validation work on each of the XML definition files by using the read XML schemas. Thus, in addition to the decompression process, the validation process used in the reference example needs to read the XML schemas by an amount corresponding to the number of XML definition files and repeat the validation work of each of the XML definition files; therefore, the validation process used in the reference example is not able to perform the validation work at high speed.

In contrast, when a plurality of XML definition files are compressed, the validation process according to the embodiment validates, at the time of XML schema validation, the encoded encoding XML definition file 133 by using the encoded inverted index 132 associated with XML schemas. Consequently, when compared with the validation process used in the reference example, in the validation process according to the embodiment, the IC load and the CPU load are decreased and it is thus possible to perform the validation work at high speed.

Furthermore, in the embodiment described above, regarding each of the tag names and the definition values of tags included in the XML schemas, the information processing apparatus 100 uses the encoding dictionary 131 and creates the inverted index 132 related to an appearance position of each of the tag names and the definition values in the XML schemas. With this configuration, the information processing apparatus 100 encodes each of the tag names and the definition values of the tags included in the XML schemas and creates the inverted index 132 related to the appearance positions of the encoded tag names and the encoded definition values in the XML schemas. Consequently, the information processing apparatus 100 can perform the validation work by using the inverted index 132 without changing the encoded XML definition files.

Furthermore, in the embodiment described above, each of the definition values of the tags includes the data type and the number of appearances. Consequently, the information processing apparatus 100 can set the definition values of the tags as the rules of the tags in the inverted index 132 and can accurately perform the validation work on the XML definition files by using the inverted index 132.

Furthermore, in the embodiment described above, the information processing apparatus 100 extracts a group of encoding data as the validation target from the encoding XML definition file 133. The information processing apparatus 100 uses the inverted index 132 and extracts a first appearance position that is associated with the start code of the extracted encoding data and a second appearance position that is associated with the end code that is obtained from the start code. Then, the information processing apparatus 100 uses the index in the inverted index 132 between the first appearance position and the second appearance position and validates the group of encoding data extracted as the validation target. With this configuration, when reading the inverted index 132 only once, the information processing apparatus 100 can validate a plurality of groups of encoding data by using the read inverted index 132 and perform the validation work at high speed.

Others

Furthermore, it has been described above that the encoding processing unit 122 in the validation unit 120 creates the encoding XML definition file 133 that is obtained by encoding each of the plurality of XML definition files. However, the process of creating the encoding XML definition file 133 obtained by encoding each of the plurality of XML definition files does not need to be performed in the validation unit 120 but may also be performed in the analysis unit 110. Furthermore, the process of creating the encoding XML definition file 133 obtained by encoding each of the plurality of XML definition files may also be performed in another functioning unit. Namely, the process of creating the encoding XML definition file 133 obtained by encoding each of the plurality of XML definition files may also be performed at the time of validation or may also be performed before validation is performed.

Furthermore, the components of each unit illustrated in the drawings are not always physically configured as illustrated in the drawings. In other words, the specific shape of a separate or integrated device is not limited to the drawings. Specifically, all or part of the device can be configured by functionally or physically separating or integrating any of the units depending on various loads or use conditions. For example, the schema validation unit 123 may also be separated into a validation unit used when the code type is a 1-byte code, a validation unit used when the code type is a 2- or 3-byte code, and validation unit used when the code type is empty. Furthermore, the schema validation unit 123 may also separate the process into a schema validation process and a start tag process. Furthermore, the analysis unit 110 may also integrate the lexical analysis unit 111 and the encoding processing unit 112. Furthermore, the validation unit 120 may also integrate the lexical analysis unit 121 and the encoding processing unit 122. Furthermore, the storage unit 130 may also be connected via a network as an external device of the information processing apparatus 100.

Hardware Configuration of the Information Processing Apparatus

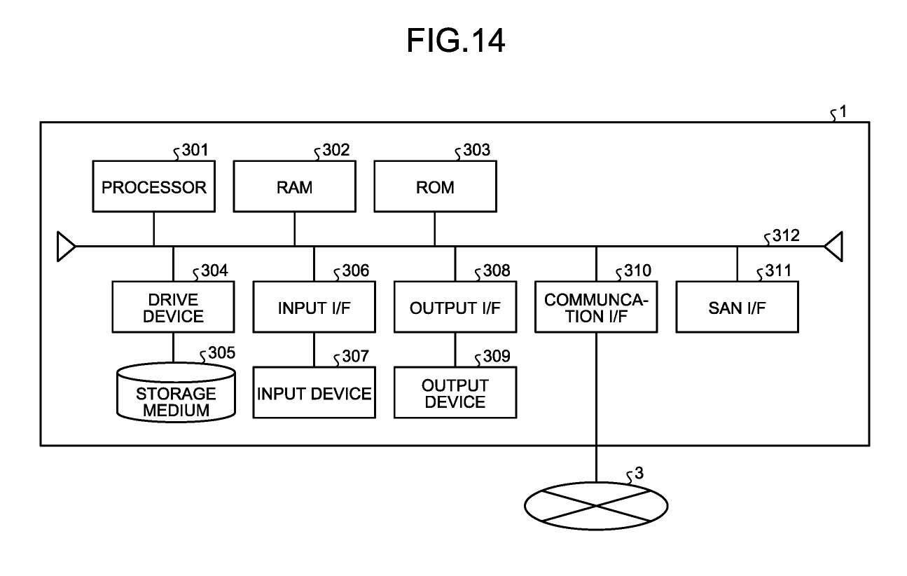

In the following, hardware and software used in the embodiment described above will be described. FIG. 14 is a diagram illustrating a hardware configuration example of a computer. A computer 1 includes, for example, a processor 301, a random access memory (RAM) 302, a read only memory (ROM) 303, a drive device 304, a storage medium 305, an input interface (I/F) 306, an input device 307, an output interface (I/F) 308, an output device 309, a communication interface (I/F) 310, a storage area network (SAN) interface (I/F) 311, a bus 312, and the like. Each of the pieces of hardware is connected via the bus 312.

The RAM 302 is a memory device that allows data items to be read and written. For example, a semiconductor memory, such as a static RAM (SRAM), a dynamic RAM (DRAM), or the like, is used or, instead of a RAM, a flash memory or the like is used. The ROM 303 also includes a programmable ROM (PROM) or the like. The drive device 304 is a device that performs at least one of the reading and writing of information recorded in the storage medium 305. The storage medium 305 stores therein information that is written by the drive device 304. The storage medium 305 is, for example, a flash memory, such as a hard disk, a solid state drive (SSD), or the like, or a storage medium, such as a compact disc (CD), a digital versatile disc (DVD), a blue-ray disk, or the like. Furthermore, for example, the computer 1 is provided with the drive device 304 and the storage medium 305 as the plurality types of storage media.

The input interface 306 is a circuit that is connected to the input device 307 and that transmits the input signal received from the input device 307 to the processor 301. The output interface 308 is a circuit that is connected to the output device 309 and that allows the output device 309 to perform an output in accordance with an instruction received from the processor 301. The communication interface 310 is a circuit that controls communication via the network 3. The communication interface 310 is, for example, a network interface card (NIC), or the like. The SAN interface 311 is a circuit that controls communication with the storage device connected to the computer 1 by a storage area network. The SAN interface 311 is, for example, a host bus adapter (HBA), or the like.

The input device 307 is a device that sends an input signal in accordance with an operation. The input signal is, for example, a keyboard; a key device, such as buttons attached to the main body of the computer 1; or a pointing device, such as a mouse or a touch panel. The output device 309 is a device that outputs information in accordance with the control of the computer 1. The output device 309 is, for example, an image output device (display device), such as a display, or an audio output device, such as a speaker. Furthermore, for example, an input-output device, such as a touch screen, is used as the input device 307 and the output device 309. Furthermore, the input device 307 and the output device 309 may also be integrated with the computer 1 or may also be devices that are not included in the computer 1 and that are, for example, connected to the computer 1 from outside.

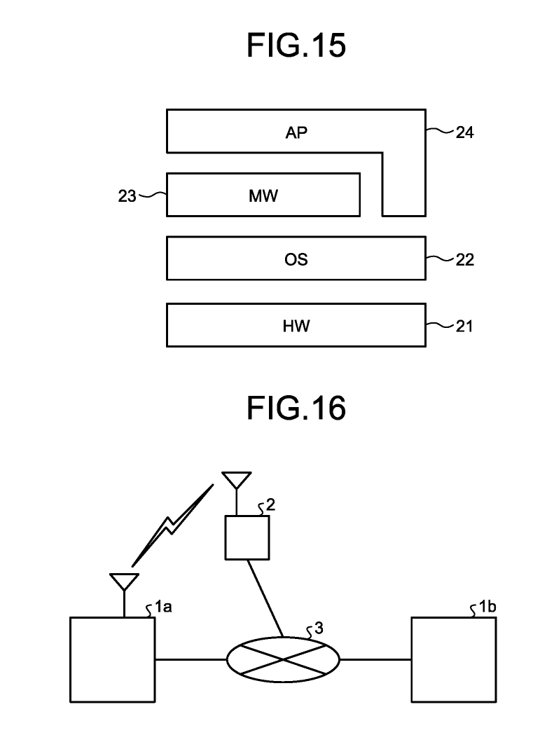

For example, the processor 301 reads a program stored in the ROM 303 or the storage medium 305 to the RAM 302 and performs, in accordance with the procedure of the read program, the processes of the analysis unit 110 and the validation unit 120. At this time, the RAM 302 is used as a work area of the processor 301. The function of the storage unit 130 is implemented by the ROM 303 and the storage medium 305 storing program files (an application program 24, middleware 23, an operating system (OS) 22, and the like, which will be described later) or data files (for example, the encoding dictionary 131, the inverted index 132, the encoding XML definition file 133, and the like) and by the RAM 302 being used as the work area of the processor 301. The program read by the processor 301 will be described with reference to FIG. 15.

FIG. 15 is a diagram illustrating a configuration example of a program running on the computer. In the computer 1, the OS 22 that controls a hardware group (HW) (301 to 312) illustrated in FIG. 14 is operated. By operating the processor 301 in accordance with the procedure of the OS 22 and by performing control and management of the hardware group (HW) 21, the processes in accordance with the application program (AP) 24 or the middleware (MW) 23 are executed in the hardware group 21. Furthermore, in the computer 1, the middleware (MW) 23 or the application program (AP) 24 is read in the RAM 302 and is executed by the processor 301.

If an analysis function is called, the processor 301 performs processes that are based on at least a part of the middleware 23 or the application program 24 (by performing the processes by controlling the hardware group 21 based on the OS 22), whereby the function of the analysis unit 110 is implemented. Furthermore, if a validation function is called, the processor 301 performs processes that are based on at least a part of the middleware 23 or the application program 24 (by performing the processes by controlling the hardware group 21 based on the OS 22), whereby the function of the validation unit 120 is implemented. Each of the analysis function and the validation function may also be included in the application program 24 itself or may also be a part of the middleware 23 that is executed by being called in accordance with the application program 24.

FIG. 16 is a diagram illustrating a configuration example of a system according to the embodiment. The system illustrated in FIG. 16 includes a computer 1a, a computer 1b, a base station 2, and a network 3. The computer 1a is connected to the network 3 that is connected to the computer 1b by using wireless or wired connection.

The analysis unit 110 and the validation unit 120 illustrated in FIG. 3 may also be included in either the computer la or the computer 1b illustrated in FIG. 16. The computer 1b may also include the function of the analysis unit 110 and the computer la may also include the function of the validation unit 120 or, alternatively, the computer la may also include the function of the analysis unit 110 and the computer 1b may also include the function of the validation unit 120. Furthermore, both the computer la and the computer 1b may also include the function of the analysis unit 110 and the function of the validation unit 120.

According to an aspect of an embodiment, in XML schema validation of a plurality of XML definition files, it is possible to perform a validation work at high speed.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium storing therein a validation program that causes a computer to execute a process comprising:
creating, by using an encoding dictionary in which a tag name or a definition value of each of a plurality of tags is associated with a code, an encoding XML definition file by encoding each of a plurality of XML definition files that are a validation target;
creating a schema association index by using the encoding dictionary from schemas associated with the plurality of XML definition files; and
validating the encoding XML definition file by using the schema association index.

2. The non-transitory validation program according to claim 1, wherein the creating the schema association index includes creating, regarding each of the tag names and the definition values of the tags included in the schemas, by using the encoding dictionary, the schema association index related to an appearance position of each of the tag names and the definition values in the schemas.

3. The non-transitory validation program according to claim 1, wherein each of the definition values of the tags includes a data type and a number of appearances.

4. The non-transitory validation program according to claim 1, wherein the validating includes
extracting a group of encoding data as the validation target from the encoding XML definition file,
extracting, by using the schema association index, a first appearance position associated with a start code of the extracted encoding data and a second appearance position associated with an end code that is obtained from the start code, and
validating, by using an index between the first appearance position and the second appearance position in the schema association index, the group of encoding data extracted as the validation target.

5. A validation device comprising:
a processor configured to:
create, by using an encoding dictionary in which a tag name or a definition value of each of a plurality of tags is associated with a code, an encoding XML definition file by encoding each of a plurality of XML definition files that are a validation target;
create a schema association index by using the encoding dictionary from schemas associated with the plurality of XML definition files; and
validate the encoding XML definition file by using the schema association index.

6. A validation method comprising:
creating, by using an encoding dictionary in which a tag name or a definition value of each of a plurality of tags is associated with a code, an encoding XML definition file by encoding each of a plurality of XML definition files that are a validation target;
creating a schema association index by using the encoding dictionary from schemas associated with the plurality of XML definition files; and
validating the encoding XML definition file by using the schema association index, by a processor.
